(19) United States
(12) Patent Application Publication
(10) Pub. No.: US 2024/0045200 A1
(43) Pub. Date: Feb. 8, 2024

(54) DEVICE FOR CLEANING AN OPTICAL SURFACE

(71) Applicants: UNIVERSITE DE LILLE, Lille (FR); CENTRALE LILLE INSTITUT, Villeneuve d'Ascq (FR); UNIVERSITE POLYTECHNIQUE HAUTS-DE-FRANCE, Valenciennes (FR); Centre National de la Recherche Scientifique, Paris (FR); Valeo Systèmes d'Essuyage, Le Mesnil Saint Denis (FR)

(72) Inventors: Michaël Baudoin, Villeneuve d'Ascq (FR); Ravinder Chutani, Lille (FR); Frederic Bretagnol, Le Mesnil-Saint-Denis (FR); Adrien Peret, Le Mesnil-Saint-Denis (FR)

(73) Assignee: Valeo Systèmes d'Essuyage, Le Mesnil Saint Denis (FR)

(21) Appl. No.: 18/267,280

(22) PCT Filed: Dec. 13, 2021
(86) PCT No.: PCT/EP2021/085483

§ 371 Date: Jun. 14, 2023

(30) Foreign Application Priority Data
Dec. 14, 2020 (FR) 2013212

(51) Int. Cl. G02B 27/00; B08B 7/02; B60S 1/56; G01S 7/497

(52) U.S. Cl. CPC G02B 27/0006; B08B 7/028; B60S 1/56; G01S 2007/4977

(57) ABSTRACT

The invention relates to a device (5) comprising: —an optical surface (10); —a cleaning unit (15) for cleaning the optical surface, comprising at least one wave transducer (70) acoustically coupled to the optical surface, the wave transducer having a piezoelectric layer (80) and electrodes (85) of opposite polarity in contact with the piezoelectric layer, and being configured to generate at least one surface ultrasonic wave (W_{S}) or a Lamb wave (W_{L}) propagating in the optical surface; —the optical surface having at least one region of optical interest (100) not superposed on the wave transducer, the device comprising an apparatus (20) configured to sense and/or to emit radiation (R) through the region of optical interest (100).

The present invention relates to a device for cleaning away a body in contact with an optical surface using ultrasound waves.

In various fields, it is necessary to overcome the effects associated with the buildup of a body, notably raindrops, ice or snow, on an optical surface.

It is known practice to cause drops of a liquid to rotate in order to remove them from a surface. However, such a technique is not suitable for surfaces with an area greater than a few square centimeters.

The use of an electrical field to control the hydrophobic property of a surface is also known, for example from KR 2018 0086173 A1. This technique, known by the acronym EWOD (which stands for ElectroWetting On Devices) consists in applying a potential difference between two electrodes so as to electrically polarize the surface and change the wetting properties thereof. By controlling the location of the polarization, the drop can then be moved. However, this technique can be implemented only with specific materials and requires the electrodes to be positioned particularly precisely over the entire surface the wetting properties of which are to be controlled.

It is also well-known practice to apply a mechanical force to the liquid, for example by means of a wiper on the windshield of a motor vehicle. However, a wiper limits the field of view accessible to the driver. It also spreads the greasy particles deposited on the surface of the windshield. In addition, the wiper blade rubbers need to be renewed regularly.

Moreover, autonomous motor vehicles include a large number of sensors to determine the distances and speeds of other vehicles on the road. Such sensors, for example lidars, are also subject to the weather and mud splashes and require frequent cleaning. However, a windshield wiper is not suitable for cleaning the small area of such a sensor. In addition, there is a need for such sensors to be compact, in order to be easily integrated within the vehicle. US 2016/0170203 A1 describes a device for cleaning a vehicle-mounted camera using ultrasound waves.

There is still a need for a device for efficiently removing a body, notably liquid, from an optical surface.

The invention seeks to meet this need and proposes a device including:
an optical surface,
a unit for cleaning the optical surface including at least one wave transducer acoustically coupled to the optical surface,

the wave transducer including a piezoelectric layer and electrodes of opposite polarity in contact with the piezoelectric layer, and being configured to generate at least one ultrasound surface wave or Lamb wave propagating in the optical surface,
the optical surface having at least one region of optical interest not superimposed with the wave transducer,

the device including an item of equipment configured to detect and/or emit radiation through the region of optical interest.

The device according to the invention thus enables the optical surface to be efficiently cleaned by means of propagation of the ultrasound surface wave, such that a body, for example a raindrop, in contact with the optical surface does not prevent efficient transmission of radiation through the optical surface. The term “layer” usually means a uniform expanse applied to or deposited on a surface.

Preferably, the transducer is arranged outside the optical field of the item of equipment. Thus, the potential shading effects that the transducer may cause on the item of equipment are limited. The detection and/or emission of radiation through the optical surface is optimized. The term “optical field” refers to the portion of space toward which the item of equipment is able to emit radiation and/or from which it is able to detect radiation.

The radiation may be visible and/or infrared and/or ultraviolet light radiation.

The device may include a processing unit configured to analyze, from among all the radiation detected by the item of equipment, only the portion that has passed through the region of optical interest. In particular, such an analysis unit is adapted in a variant in which all or part of the transducer is contained within the optical field of the item of equipment.

Preferably, the transducer is arranged at the periphery of the optical surface. In this way, thus, in addition to its low interaction with the functioning of the item of equipment, the transducer can be readily protected, for example by a support bearing the optical surface.

Preferably, the wave transducer extends from one edge of the optical surface over a distance of less than 10%, or even less than 5% of the length of the optical surface. The term “length of the optical surface” means the distance separating two opposite edges of the optical surface along one face of the optical surface.

Preferably, the transducer extends from one edge of the optical surface over a distance of less than 30 mm, preferably less than 20 mm preferably less than 10 mm.

The transducer is preferably in contact with the optical surface.

The transducer may be fixed to the optical surface in various ways.

For example, the transducer may take the form of a foil which is transferred onto the optical surface. The term “foil” means a thin flexible film, notably having a thickness of less than 100 μm.

It may be bonded to the optical surface, notably by means of a polymer adhesive which also acoustically couples the transducer to the optical surface. The adhesive may be UV-curable. It is, for example, an epoxy resin. The transducer may be attached by molecular adhesion or by means of a thin metal layer that provides the adhesion between the optical surface and the piezoelectric layer. The layer may be made of a metal or an alloy having a low melting point, i.e. having a melting point below 200° C., for example an indium alloy. As a variant, the metal layer may be made of a metal or an alloy having a melting point above 200° C., for example an aluminum and/or gold alloy.

An example of bonding via molecular adhesion is described in “Glass-on-LiNbO₃ heterostructure formed via a two-step plasma activated low-temperature direct bonding method”, J. Xu et al., Applied Surface Science 459 (2018) 621-629, doi: 10.1016/j.apsusc.2018.08.031. According to another variant, the transducer may be fixed to the optical surface by means of a process including a step of melting a portion of the piezoelectric layer and/or a portion of the optical surface, followed by a step consisting in compressing the piezoelectric layer and the optical surface together, the respective molten portions of the optical surface and of the piezoelectric layer being in contact with each other. According to another variant, the transducer may be fixed to the optical surface by means of a process including depositing bonding layers made of a low-melting alloy to a portion of the transducer and to a portion of the optical surface, respectively, at least partially melting said bonding layers, then compressing the piezoelectric layer and the optical surface, the faces of the bonding layers that are opposite faces from those facing the optical surface and the piezoelectric layer being brought into contact with each other during the compression. The bonding layers may be applied by cathodic sputtering, or using an evaporation technique used in the field of the application of thin layers.

The transducer may be placed between the optical surface and the item of equipment. Thus, the transducer may be protected by the optical surface from the weather and/or projections. Preferably, the transducer is then shaped to generate a Lamb wave so as to reach the face, opposite to the item of equipment and in contact with which a body, for example a raindrop, may be deposited.

In one variant, the optical surface may be arranged between the transducer and the item of equipment. Preferably, the transducer is then in contact with the face of the optical surface that is opposite the item of equipment. It may be configured to emit an ultrasound surface wave propagating on that face. In particular, the device may include a cover superimposed on the transducer and shaped to define a protective housing for the transducer.

Preferably, the piezoelectric layer is in the form of a strip that extends over a face of the optical surface. Preferably, the strip extends along and preferably parallel to an edge of the optical surface.

In particular, the piezoelectric layer may form a surround at least partially, notably entirely, framing the region of optical interest. The exterior contour and/or the interior contour of the surround may be homothetic with the contour of that face of the optical surface on which the piezoelectric layer is applied.

The thickness of the piezoelectric layer may be selected according to the wavelength A of the ultrasonic surface wave. As a preference, the thickness of the piezoelectric layer is less than or equal to 5*λ, preferably less than or equal to 1,5*λ, preferably less than or equal to A, or even less than or equal to 0,5*λ, notably for an ultrasonic surface wave with a frequency comprised between 0.1 MHz and 60 MHz. The piezoelectric layer may have a thickness of between 1 μm and 300 μm. It may have a thickness of less than or equal to 100 μm, less than 50 μm or even less than 10 μm.

The ratio of the thickness of the optical surface to the thickness of the piezoelectric layer is preferably greater than 2, preferably greater than 10, or even greater than 50.

It may be applied to the optical surface using a process chosen from physical vapor deposition, chemical vapor deposition, magnetron sputtering and electron cyclotron resonance.

The piezoelectric layer may be made of a material chosen from the group formed by lithium niobate, aluminum nitride, zinc oxide, lead zirconate titanate, and mixtures thereof.

The piezoelectric layer may be opaque to light. In one variant, it layer may be transparent.

The term “transparent” means transparency to light radiation in the visible range and/or to radiation in the infrared range and/or to radiation in the ultraviolet range.

The electrodes are of opposite polarity, i.e. they are intended to be electrically powered with electrical voltages of opposite signs.

The polarity electrodes may each have a comb including a branch from which fingers extend. The combs are preferably interdigital.

Each of the fingers of a comb may have a width equal to the fundamental wavelength of the ultrasound surface wave or the Lamb wave, divided by 4, and the spacing between two consecutive fingers of a comb may be equal to the fundamental wavelength of the ultrasound surface wave or of the Lamb wave, divided by 4. The spacing between the fingers determines the resonant frequency of the transducer, which a person skilled in the art is easily capable of determining. Applying alternating electrical voltages to the electrodes of opposite polarities induces a mechanical response in the piezoelectric material, resulting in the generation of an ultrasound surface wave or of a Lamb wave, which propagates in the optical surface.

The electrodes may be made of metal. They may be made of chromium, or aluminum or a combination of an adhesion-promoting layer such as titanium with a conducting layer such as gold.

In variants, the electrodes may be made of a conductive transparent oxide, for example chosen from indium tin oxide, aluminum-doped zinc oxide, and mixtures thereof. In particular, the transducer may be transparent and be formed from such electrodes and a transparent piezoelectric layer of lithium niobate or zinc oxide. The transducer may thus be advantageously arranged in the optical field of the item of equipment, for example to optimize the cleaning of the optical surface, without significantly interfering with the functioning of the item of equipment due to shadowing.

The electrodes may be applied to the piezoelectric layer by an evaporative or sputtering process and shaped using photolithography.

They may be printed, for example using ink-jet printing. In particular, they may be printed on a foil, for example made of a flexible thermoplastic material, and may be applied by transferring the foil onto the piezoelectric layer.

The transducer may be configured to emit an ultrasound surface wave or a Lamb wave with a fundamental frequency that may be between 0.1 MHz and 1000 MHz, preferably between 10 MHz and 100 MHz, for example equal to 40 MHz, and/or with an amplitude that may be between 1 nanometer and 500 nanometers. The amplitude of the wave corresponds to the normal displacement of the face of the optical surface over which the ultrasound surface wave is propagating. It can be measured using laser interferometry.

The ultrasound surface wave may be a Rayleigh wave, when the optical surface has a thickness greater than the wavelength of the ultrasound surface wave. A Rayleigh wave is preferred because a maximum proportion of the wave energy is concentrated on the face of the optical surface over which it is propagating, and can be transmitted to a body, for example a raindrop, lying on the optical surface.

Preferably, the device includes at least two transducers, for example more than five, or even more than ten transducers.

The transducers may be configured to emit acoustic surface waves that propagate in directions that are parallel or that are secant. For example, the device includes at least three transducers which are configured so that the directions of propagation of the waves that they are able to generate intersect at a common location.

The transducers may be evenly distributed over the contour of the face of the optical surface on which they are arranged.

Preferably, the transducers share the same piezoelectric layer. In other words, the electrodes of the various transducers may be in contact with the same piezoelectric layer. Such a device is thus easy to manufacture, by successively implementing a step of deposition of the piezoelectric layer followed by a step of deposition of the electrodes to form the transducers.

The optical surface may be self-supporting, in the sense that it is able to deform, notably elastically, without breaking under its own weight.

The face of the optical surface over which the ultrasound surface wave or the Lamb wave propagates may be planar. It may also be curved, provided that the radius of curvature of the face is greater than the wavelength of the ultrasound surface wave. Said face may be rough. The roughness lengths are preferably shorter than the fundamental wavelength of the ultrasound surface wave, so as to avoid their significantly affecting the propagation thereof.

The optical surface may take the form of a plate that is planar or that has at least one curvature in one direction. In particular, it may be a lens. The thickness of the plate may be between 100 μm and 5 mm. The length of the plate may be greater than 1 mm. or even greater the 1 cm, or even greater than 1 m.

The term “thickness of the optical surface” considers the shortest dimension of the optical surface as measured in a direction perpendicular to the surface over which the ultrasound surface wave or the Lamb wave propagates.

The optical surface may be set out flat relative to the horizontal. As a variant, it may be inclined with respect to the horizontal by an angle α greater than 10°, or even greater than 20°, or even greater than 45°, or even greater than 70°. It may be set out vertically.

The optical surface is preferably optically transparent, notably to visible light or to ultraviolet or infrared radiation.

Moreover, the optical surface may have a single-layer or multi-layer coating covering one face of the acoustically conducting portion.

The coating may notably include a hydrophobic layer, an antireflection layer, or a stack of these layers. For example, the hydrophobic layer consists of self-assembled monolayers of OTS or may be produced by deposition of a fluorine-based plasma. The coating may include one or more antireflection layers depending on the intended application (visible, IR, etc.).

The transducer may be in contact with the acoustically conducting portion and the hydrophobic layer may completely cover the transducer, so as to protect it from contact with water. In a variant, the coating is positioned between the transducer and the acoustically conducting portion.

Preferably, the optical surface includes an acoustically conducting portion, the transducer being acoustically coupled to, and preferably in contact with, the acoustically conducting portion.

The acoustically conducting portion is preferably transparent.

The acoustically conducting portion preferably has an attenuation length greater than the length of the optical surface, or even greater than 10 times the length of the optical surface, or actually even greater than 100 times the length of the optical surface.

The acoustically conducting portion may be made of any material that is capable of propagating an ultrasound surface wave or a Lamb wave. Preferably, it is made of a material having an elastic modulus of greater than 1 MPa, for example greater than 10 MPa, or even greater the 100 MPa, or actually even greater than 1000 MPa, or indeed even greater than 10 000 MPa. A material having such an elastic modulus has a stiffness particularly suited to the propagation of an ultrasound surface wave or of a Lamb wave.

Preferably, the acoustically conducting portion is made of glass or of poly(methyl methacrylate), also known under the trade name Plexiglas®.

The optical surface may consist of the acoustically conducting portion.

In a variant, the optical surface may include an acoustically insulating portion, i.e. a portion that absorbs the ultrasound surface wave or the Lamb wave, over a distance less than the length of the optical surface, or even less than 0.1 times the length of the optical surface. The acoustically insulating portion is preferably superposed, notably integrally, with the acoustically conducting portion. The acoustically insulating portion may completely cover the acoustically conducting portion. Preferably, the acoustically insulating portion is made of polycarbonate. Other rubbery or plastic materials may be envisioned.

The acoustically insulating portion is preferably transparent.

In particular, the acoustically insulating portion and the acoustically conducting portion may be stacked one upon the other, and preferably in contact with one another. In particular, the acoustically conducting portion may have a thickness at least five times smaller than the thickness of the acoustically insulating portion. Thus, the acoustically insulating portion may confer mechanical strength on the optical surface while the acoustically conducting portion provides the possibility of performing cleaning by carrying the ultrasound wave.

The acoustically conducting portion may be mounted removably on the acoustically insulating portion. Thus, it is easily possible to replace one of said portions when it is damaged, for example following contact with a solid body, for example a stone, when the device is in motion.

In particular, the acoustically conducting portion may be bonded to the acoustically insulating portion using a reversible adhesive.

The item of equipment is configured to detect and/or emit radiation. To this end, it includes a radiation sensor and/or emitter.

In particular, the item of equipment may be chosen from optical remote sensing apparatus, for example lidar, photographic apparatus, a camera, a radar, an infrared sensor and an ultrasonic range finder.

The optical surface may be superimposed on the sensor and/or emitter, notably as a means of protecting the sensor. Preferably, the optical surface is at a distance from the sensor and/or the emitter.

It may be a lens designed to deflect the radiation toward the sensor or from the emitter.

As a variant, it may be an optical protection member, for example to protect the sensor and/or the emitter. An “optical protection member” is such that it does not deflect the optical path of radiation passing through it.

In particular, the item of equipment includes the optical surface which is a lens or the optical surface is a protective member of the item of equipment.

The device may be a motor vehicle and the item of equipment is configured to acquire a variable chosen from the distance between the vehicle and an object, the speed of the vehicle, the positioning of the vehicle relative to a traffic lane, and also any complementary information such as the nature of the vehicle (truck, bicycle, etc.) or the nature of objects (civilians, animals, etc.).

As a variant, the optical surface may be a substrate of a lab-on-a-chip, notably intended for microfluidic applications.

The optical surface may be a wall exposed to the condensation of a liquid that can solidify, for example a window pane of a building.

The device, notably the item of equipment, may include a housing in which the sensor and/or emitter is housed and the optical surface may be removably mounted on the housing. In particular, the optical surface may be attached to the housing in such a way as to hermetically seal the housing, so as to protect the sensor and/or emitter. The optical surface may notably be fixed on a mount, which may be screwed onto the housing. Thus, the optical surface may be readily replaced if it becomes damaged.

Moreover, the cleaning unit may include an electricity generator to electrically power the transducer, so that the transducer converts the electrical supply signal into an ultrasound surface wave or into a Lamb wave.

The invention also relates to the use of a device according to the invention for removing a body that is in contact with the optical surface out of the region of optical interest.

The use may involve electrically powering the cleaning unit in order to melt the body when the body is in the solid state, and/or to keep the body in the liquid state when the temperature of the optical surface is below the temperature at which the body solidifies.

The body in the liquid state may take the form of at least one drop or at least a film. The energy of the ultrasound surface wave may be enough to cause the body in the liquid state to move over the face of the optical surface. The body may be aqueous, and is notably rainwater or condensation. The temperature of the optical surface may be below 0° C.

The body is, for example, frost or snow.

Finally, the invention relates to a vehicle, preferably an automated vehicle, or a component of such a vehicle including a device according to the invention.

The term “automated vehicle” means a vehicle which may be driven on an open road without the intervention of a human driver. The vehicle is preferably a motor vehicle, notably a car or a truck.

A component of such a vehicle may be chosen from a headlamp module, a system containing a collection of various sensors, also referred to as a “pod”, at least one side window, a front screen or rear screen and a driving assist unit.

The invention may be understood more clearly on reading the following detailed description of nonlimiting implementation examples thereof, and on examining the appended drawing, in which:

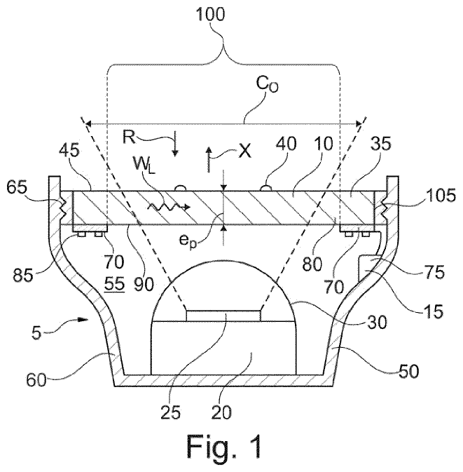

FIG. 1 schematically depicts, in cross section, an example of a device according to the invention,

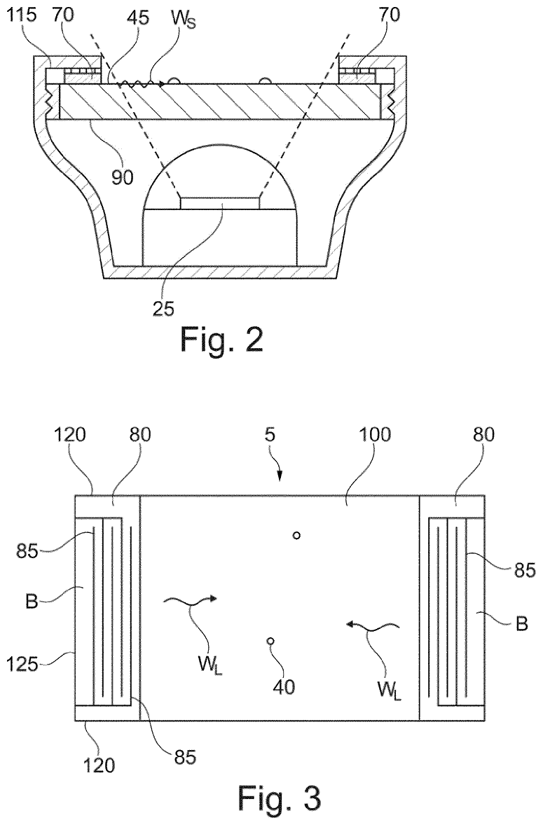

FIG. 2 schematically depicts another example of a device,

FIG. 3 schematically depicts, in front view, a portion of an example of a device according to the invention,

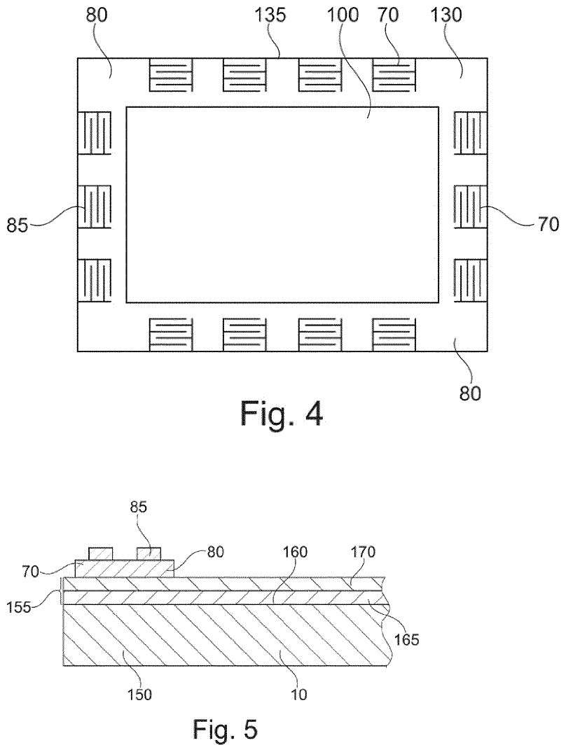

FIG. 4 schematically depicts, in front view, a portion of another example of a device according to the invention,

FIG. 5 schematically depicts, in cross section, a portion of an example of a device according to the invention,

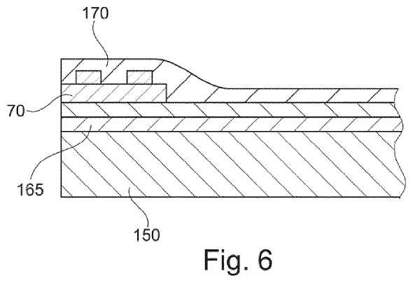

FIG. 6 schematically depicts, in cross section, a portion of another example of a device according to the invention, and

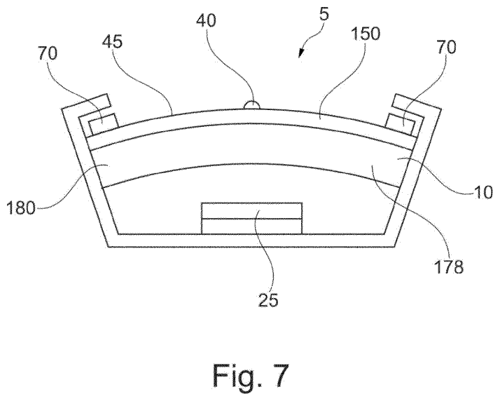

FIG. 7 schematically depicts, in cross section, an example of a device according to the invention.

For the sake of clarity, the elements that make up the drawings have not always been drawn to scale.

FIG. 1 illustrates a first example of a device 5 according to the invention.

The device includes an optical surface 10, an optical surface cleaning unit 15 and an item of equipment 20.

The item of equipment 20 includes a sensor 25 to detect radiation R and a lens 30 to direct the radiation R toward the sensor. As a variant or in addition, it may include an emitter to emit radiation. For example, the equipment includes a lidar which is configured to emit laser radiation and in return detect that part of this laser radiation that has been reflected by an object.

Moreover, the lens 30 is optional. In an implementation example not shown, the item of equipment does not have one.

The item of equipment defines an optical field Co which corresponds to the portion of space from which it is able to detect radiation. Outside of this optical field, even though the radiation may be able to reach the sensor, the latter is not able to detect it.

The optical surface 10 completely covers the sensor 25 and is thus a protective member 35 of the item of equipment. For example, the device is mounted on a motor vehicle that may move in an X direction, the optical surface forms a barrier against bodies 40, such as dust, mud particles and raindrops that come into contact with the face 45 of the optical surface opposite the sensor.

Moreover, the optical surface is transparent to the radiation received by the sensor. The optical surface is, for example, made of glass. However, it may be made of a material that is opaque to radiation in the visible range but transparent to the wavelengths of the radiation that the sensor is capable of detecting.

In the illustrated example, the optical surface is in the form of a disk whose thickness eₚ is, for example, between 0.5 mm and 5 mm. In a variant, the optical surface may be curved, and may, for example, have the shape of a lens.

The device may, as illustrated, include a housing 50 which defines a chamber 55 housing the sensor. The chamber 55 may notably be delimited by a solid wall 60 of the housing and by the optical surface 10 so as to be airtight and watertight. The sensor is thus protected against the weather.

In particular, the optical surface may close off the housing. For example, the optical surface is mounted on a ring 65 which is screwed onto the housing 50.

The optical surface is thus removable, which allows for simple replacement thereof when, for example, it has been damaged by a projectile.

The optical surface cleaning unit 15 includes two transducers 70 which are arranged in contact with and acoustically coupled to the optical surface. The cleaning unit also includes a current generator 75 electrically powering the transducers. The number of transducers is nonlimiting. Notably, the device may include a single transducer.

The transducers moreover each include a piezoelectric layer 80 and electrodes 85 of opposite polarity arranged on the piezoelectric layer. Such layered transducers thus allow the manufacture of particularly compact devices. They may also be easily arranged on curved optical surfaces.

The transducers may each generate an ultrasound surface wave W_{S} or a Lamb wave W_{L} that propagates in the optical surface. In the example illustrated in FIG. 1, the transducers are arranged on the face 90 of the optical surface 10 opposite to the face 45 that is to be cleaned. They are preferably configured to generate a Lamb wave that reaches the face 45 that is to be cleaned.

Moreover, the transducers delimit a region of optical interest 100 which is not superposed with the transducers.

Preferably, part of the region of optical interest is contained within the optical field of the item of equipment In other words, the transducers are positioned outside of the optical field of the equipment so that they create almost no interference with the radiation passing through the region of optical interest and detected by the sensor.

In order to reduce the bulk, as illustrated in FIG. 1, the transducers are preferably arranged at the periphery of the optical surface. Thus, it is possible to maximize the area of the region of optical interest by offsetting the transducers to the periphery. Each wave transducer may notably extend from an edge of the optical surface over a distance less than 10%, or even less than 5% of the length of the optical surface.

In the example shown, the transducers extend on the face 90 directly from the edge 105.

The device of FIG. 2 differs from that shown in FIG. 1 in that the transducers 70 are arranged on the face 45 to be cleaned of the optical surface 10 that is opposite the face 90 facing the sensor 25.

The transducers are preferably configured to generate an ultrasound surface wave W_{S} propagating along the face 45 to be cleaned so as to move a body in contact with said face.

As illustrated, optionally, the housing 50 has a shoulder 115 that forms a cover and covers the transducers 70, so as to protect them from the weather.

FIG. 3 illustrates part of a device 5 according to the invention according to a view perpendicular to one of the faces 45, 90 of the optical surface.

Two transducers are arranged in contact with one of the faces of the optical surface. They each include a piezoelectric layer 80 which is in contact with the optical surface and which extends in a band B between two opposite edges 120 and parallel to a third edge 125 which connects these two opposite edges. Electrodes 85 of opposite polarity and including interdigitated combs are arranged on the piezoelectric layer, and are arranged so as to generate a Lamb W_{L} or surface W_{S} ultrasound wave that propagates through the region of optical interest, so as to clean the bodies 40 deposited thereon.

The portion of the device depicted in FIG. 4 differs from the one illustrated in FIG. 3 in that the transducers 70 share the same piezoelectric layer 80 which delimits a surround 130 which frames the region of optical interest 100. The surround is, for example, rectangular. The surround has an exterior contour 135 which coincides with the contour of that face of the optical surface on which the piezoelectric layer is applied. In addition, the device may include a larger number of transducers, for example arranged evenly around the surround. To facilitate the manufacture of such a device, the electrodes 85 may be printed on the piezoelectric layer. An arrangement of the transducers as described in FIGS. 3 and 4 may, of course, be implemented in the examples shown in FIGS. 1, 2 and 7.

FIG. 5 is a view in cross section of part of the device of FIG. 3. The optical surface 10 includes an acoustically conducting portion 150, for example made of glass, and a coating 155 completely covering one face 160 of the acoustically conducting portion and made up of a stack of an antireflection layer 165 and a hydrophobic layer 170 so as, for example, to prevent raindrops from spreading over the optical surface and to make them easier to remove. The transducer 70 is positioned in contact with the coating opposite the acoustically conducting portion. The coating preferably has a thickness that is small enough with respect to the wavelength of the surface wave generated by the transducer. Thus, the acoustically conducting portion and the transducer are acoustically coupled.

The device illustrated in FIG. 6 differs from the device illustrated in FIG. 5 in that the transducer 70 is sandwiched between the hydrophobic layer 170 and the acoustically conducting portion 150. Thus, the hydrophobic layer protects the transducer.

Finally, FIG. 7 illustrates yet another exemplary embodiment of a device 5 according to the invention. It differs from the example in FIG. 2 in that the optical surface is a lens 178 including an acoustically conducting portion 150 and an acoustically insulating portion 180 stacked on top of each other.

In addition to its ability to modify the path of radiation passing through it, the lens 178 also protects the sensor 25.

Moreover, the acoustically insulating portion is, for example, thicker than the acoustically insulating portion and can mechanically support the acoustically conducting portion. The transducer is acoustically coupled to the acoustically conducting portion.

The acoustically conducting portion may be removably mounted, for example, by means of a reversible adhesive layer arranged between the opposing faces of the acoustically insulating portion and the acoustically conducting portion. Thus, the acoustically insulating portion can be readily replaced.

The acoustically conducting portion 150 is arranged opposite the sensor 25 relative to the acoustically insulating portion 180. Thus, the cleaning unit can clean the face 45 of the acoustically conducting portion on which bodies 40, for example raindrops, may collect.

Needless to say, the invention is not limited to the implementation examples of the invention that have been presented as nonlimiting illustrations.

1. A device comprising:
an optical surface;
a unit for cleaning the optical surface including at least one wave transducer acoustically coupled to the optical surface, the wave transducer including a piezoelectric layer and electrodes of opposite polarity in contact with the piezoelectric layer, and being configured to generate at least one ultrasound surface wave or Lamb wave propagating in the optical surface,
the optical surface having at least one region of optical interest not superimposed with the wave transducer; and
an item of equipment configured to detect and/or emit radiation through the region of optical interest.

2. The device as claimed in claim 1, the wave transducer being arranged outside the optical field of the item of equipment.

3. The device as claimed in claim 1, further comprising: a processing unit configured to analyze only the radiation detected by the optical apparatus through the region of optical interest.

4. The device as claimed in claim 1, the transducer being arranged at the periphery of the optical surface.

5. The device as claimed in claim 1, wherein the wave transducer extends from an edge of the optical surface over a distance of less than 10%, or even less than 5% of the length of the optical surface.

6. The device as claimed in claim 1, the transducer extending from an edge of the optical surface over a distance of less than 30 mm, preferably less than 20 mm, preferably less than 10 mm.

7. The device as claimed in claim 1, the piezoelectric layer forming at least one strip extending over one face of the optical surface.

8. The device as claimed in claim 1, the piezoelectric layer forming a surround at least partially framing the region of optical interest.

9. The device as claimed in claim 1, including several wave transducers which share the same piezoelectric layer.

10. The device as claimed in claim 1, the wave transducer being in contact with the optical surface, and the transducer being fixed to the optical surface, for example bonded by a polymeric adhesive which acoustically couples the transducer to the optical surface or by molecular adhesion or by a thin metallic layer providing adhesion between the optical surface and the piezoelectric layer, or by a process including a step of melting a portion of the piezoelectric layer and/or a portion of the optical surface followed by compressing the piezoelectric layer and the optical surface together, the respective melted portions of the optical surface and the piezoelectric layer being in contact with each other.

11. The device as claimed in claim 1, the optical surface including an acoustically conducting portion made of glass, the wave transducer being acoustically coupled to the acoustically conducting portion, and preferably being in contact with the acoustically conducting portion.

12. The device as claimed in claim 11, the optical surface including a stack including an acoustically insulating portion and the acoustically conducting portion, these being stacked one on the other.

13. The device as claimed in claim 12, the acoustically conducting portion being removably mounted on the acoustically insulating portion.

14. The device as claimed in claim 1, the item of equipment including the optical surface which is a lens, or the optical surface is a protective member of the item of equipment.

15. The device as claimed in claim 1, the thickness of the piezoelectric layer being less than or equal to 0.5*λ, notably for an ultrasonic surface wave with a frequency comprised between 0.1 MHz and 60 MHz.

16. The device as claimed in claim 1, the piezoelectric layer having a thickness of between 1 μm and 300 μm.

17. An automated vehicle, including a device as claimed in claim 1.
